(19) United States
(12) Patent Application Publication
(10) Pub. No.: US 2025/0085040 A1
(43) Pub. Date: Mar. 13, 2025

(54) Stackable Ice Block Mold with Handle

(71) Applicants: Willie C. Floyd, Chapin, SC (US); Matthew Grissom, Southport, NC (US)

(72) Inventors: Willie C. Floyd, Chapin, SC (US); Matthew Grissom, Southport, NC (US)

(21) Appl. No.: 18/464,385

(22) Filed: Sep. 11, 2023

(51) Int. Cl. F25C 1/04; B25G 3/00

(52) U.S. Cl. CPC F25C 1/04; B25G 3/00

(57) ABSTRACT

A stackable ice block mold includes a removable support bar that extends across an upper portion of ice block mold from one side to an opposing side thereof, and a handle member that includes a pair of legs extending downwardly therefrom. The handle member is preferably positioned above the removable support bar, in some embodiments, and the legs extend downwardly into the ice block mold. The ice block mold is filled with water, so that the water level is below handle member in some embodiments, and so that the legs extending downwardly from the handle member are substantially submerged in the water. Upon freezing, the legs of the handle member are frozen into the ice block, allowing the handle to carry the ice block. The mold may be collapsible, and the handle may be recessed into the ice block, and the ice blocks themselves are stackable in various embodiments.

### BACKGROUND OF THE INVENTION

The present invention relates to stackable ice molds. More specifically, the present invention includes a stackable ice mold and a handle member that is partially frozen into an ice block to facilitate easy transport of the ice block.

Block ice is used for various activities, and is particularly useful for fishing applications, because block ice stays frozen much longer than smaller cubes of ice that are commonly sold in bags at convenience stores, grocery stores, or the like. Further, freezer space is at a premium, so it would be desirable to provide stackable ice molds that may be efficiently stacked and stored within a freezer space, significantly reducing the amount of wasted space therein.

Moreover, once the ice block is sufficiently frozen, it would be desirable to provide a means for carrying the ice blocks themselves by providing handles attached to the ice blocks. Additionally, it would be desirable to provide stackable ice blocks with handles.

Many types of ice block molds have been developed over the years, and examples of different types of ice molds are set forth in the following cited documents, which are hereby incorporated herein by reference, in their entireties:

### U.S. Pat. No. 4,498,595

A method and apparatus for the home freezing of water in relatively large blocks for subsequent use in insulated portable ice chests for maintaining the contents cool over a period of days is disclosed and includes a plurality of support racks of truncated pyramidal configuration having open rectangular tops and bottoms and trapezoidal side walls of an open mesh configuration along with a like plurality of relatively flat floor panels each having a groove for receiving an upper edge of a subadjacent rack and a groove for receiving an edge of a superior rack so that a plurality of flexible open topped containers may be stacked in a column in a freezer on successive floor panels with each floor panel supported by a corresponding rack to allow free air circulation around the containers to facilitate cooling as well as supporting and storing the water and the subsequent blocks of ice.

### U.S. Pat. No. 5,884,490

A Support arrangement for Supporting a flexible, water containing mold of intricate configuration in a tank having Supporting Sides and containing a chilled liquid, such that an item of crystal clear ice can be created in the flexible mold. The flexible mold has an upper, Support portion and a lower, principal portion, and also has interior surfaces possessing a distinctive degree of roughness. The support arrangement involves elongate support means for operatively engaging the upper portion of the mold, with the elongate support means being of a length sufficient to span between the supporting sides of the tank such that the mold can be supported with a selected extent of the principal portion of the mold immersed below the surface of the chilled liquid. Circulation of the water in the mold is brought about so that the interior sides of the mold will be swept, thus preventing the formation of cloudy ice. The arrangement for causing circulation of the water in the mold may involve a gas supply utilized for supplying controlled amounts of gas to a lower interior portion of the mold so that suitable amounts of gas can be caused to rise up through the water in the mold and prevent the formation of cloudy ice. Other arrangements for causing circulation of the water in the mold may include power driven rotatable means disposed in the mold.

### US Patent Application Pub. No. 2007/0262230

A stackable mold for making block ice is disclosed. The bottom edges of the sidewall of the mold have stacking lips and the top edges of the sidewall have stacking ledges. The stacking ledges of a lower mold mate with the stacking lips of an upper mold, thereby allowing multiple molds to be stacked on top of one another. Guide lips along the sidewalls of the mold prevent slipping and shifting of the stacked molds. The tapered property of the molds creates space between the bottom of an upper mold and the top of a lower mold to allow airflow through the lower mold. A reinforcing lip extends along the top of the long sides for reinforcement.

### US Patent Application Pub. No.: 2012/0055188

A combination ice cube tray and ice cube lifter includes a tray having a plurality of openings and a lifting device. The tray has one or more recesses, each of which has a bottom wall and side walls that extend upwardly from and contiguously around the bottom wall for forming one or more ice cubes therein. The lifting device has a base portion and a top member. The base portion includes one or more cradles configured to seat within the one or more recesses of the tray to seat against the bottom wall of each of the one or more recesses of the tray. Each of the one or more cradles is coupled to an upstanding member. The top member couples to the upstanding members. A method for lifting ice cubes from a tray is also disclosed.

### U.S. Pat. No. 11,311,025

The present disclosure extends to apparatuses, methods, and systems for freezing a liquid suitable for use by a frozen confection machine. The apparatuses, methods, and systems include a two-piece form suitable for producing a dense ice structure.

### SUMMARY OF THE INVENTION

The present invention, in one embodiment, includes an ice block mold having a bottom and four sides for holding water to create an ice block, a removable support bar that extends across an upper portion of ice block mold from one side to an opposing side thereof, and a handle member that includes a pair of legs extending downwardly therefrom. The handle member is positioned above the removable support bar, and the legs extend downwardly into the ice block mold. The removable support bar may further include a cradle to support the handle member.

In use, the ice block mold is filled with water, so that the water level is below handle member and the removable support bar, and so that the legs extending downwardly from the handle member are mostly submerged in the water. The bottom portions of the legs may each include a flange or foot. After the appropriate water level has been reached, then the ice block mold is placed into a freezer until the ice block is frozen.

To remove the ice block from the mold, the removable support bar is removed, and a user may simply grasp the handle to pull the ice block from the mold. The legs of the handle are frozen into the ice block, so that the handle may be used to carry and transport the ice block. As the ice eventually melts, the handle is then freed for additional use to make another ice block in the mold.

Other embodiments may include an ice mold that is similar to the embodiment described above, but further includes a raised section at the bottom of the mold, directly below the handle member. In this version, the raised section at the bottom of the mold creates an indentation in the ice block, so that the ice blocks may be stackable with the handles attached. In other words, the indentation in the bottom of one ice mold creates space for the handle, so that when one ice block is place on top of another, the handle of the lower ice block is received into the indentation at the bottom of the upper ice block.

It is also contemplated that the handle member may include a shield or hand guard that is sunk into the ice, so that the handle member is recessed into the ice, which also provides for stackable ice blocks that include a reusable handle member. In this embodiment, the upper portion of the hand guard and handle are generally flush with, or positioned in the same plane as the top side of the frozen ice block, for purposes of stackability. Additionally, the mold itself may be collapsible in any suitable manner, for purposes of storage and transport.

### DESCRIPTION OF THE DRAWINGS

These and other features, aspects, and advantages of the present invention will become better understood with regard to the following description and accompanying drawings where:

FIG. 1 is a perspective view of one embodiment of a stackable ice mold, showing a generally square shaped mold having a bottom and four sides, and further showing a liner disposed within the mold, a removable support member extending across an upper portion of the mold from a first side to an opposed side, wherein the support member includes a cradle member for supporting a rigid handle member, and further showing the handle member having a pair of legs extending downwardly, each leg including a round flange at a bottom portion thereof;

FIG. 2 is a top view of the embodiment of a stackable ice mold as shown in FIG. 1;

FIG. 3 is a side view of the embodiment of a stackable ice mold as shown in FIG. 1;

FIG. 4 is a front view of the embodiment of a stackable ice mold as shown in FIG. 1;

FIG. 5 is a perspective view of one embodiment of a stackable ice mold, showing a generally square shaped mold having a bottom and four sides, wherein the bottom of the mold includes an indentation directly beneath the handle member, which causes an indentation in the bottom of an ice block to receive a handle member when the ice blocks are stacked on top of one another, and further showing a liner disposed within the mold, a removable support member extending across an upper portion of the mold from a first side to an opposed side, wherein the support member includes a cradle member for supporting a handle member, and further showing the handle member having a pair of legs extending downwardly, each leg including a round flange at a bottom portion thereof;

FIG. 6 is a top view of the embodiment of a stackable ice mold as shown in FIG. 5;

FIG. 7 is a side view of the embodiment of a stackable ice mold as shown in FIG. 5;

FIG. 8 is a front view of the embodiment of a stackable ice mold as shown in FIG. 5;

FIG. 9 is a perspective, exploded, cutaway view of a stack of ice blocks formed from the mold shown in FIGS. 5-8, wherein the handle member on each ice block is received into the indentation on the bottom side of the ice block stacked directly thereabove;

FIG. 10 is a perspective view of another embodiment of a stackable ice mold showing a generally square shaped mold having a bottom and four sides, and further showing a liner disposed within the mold, a removable support member extending across an upper portion of the mold from a first side to an opposed side, wherein the support member includes a cradle member for supporting a handle member on an underside thereof, and further showing the handle member that snap fits into the cradle member, the handle member including a hemispherically shaped hand guard for partial submersion into water to be frozen, so that the handle member is recessed into an ice block after the water is frozen, the handle further including a pair of legs extending downwardly, each leg including a round flange at a bottom portion thereof;

FIG. 11 is a top view of the embodiment of a stackable ice mold as shown in FIG. 10;

FIG. 12 is a side view of the embodiment of a stackable ice mold as shown in FIG. 10;

FIG. 13 is a front view of the embodiment of a stackable ice mold as shown in FIG. 10;

FIG. 14 is a perspective, exploded, cutaway view of a stack of ice blocks formed from the mold shown in FIGS. 10-13, wherein the handle member on each ice block includes a recessed handle member and hand guard, wherein the upper portion of the hand guard and handle member are generally flush and in the same plane as the upper side of the ice block;

FIG. 15 is a perspective view of one embodiment of a stackable ice mold, showing a generally square shaped mold having a bottom and four sides, and further showing a liner disposed within the mold, a removable support member extending across an upper portion of the mold from a first side to an opposed side, wherein the support member includes a cradle member for supporting a flexible handle member such as a rope, and further showing the rope handle member extending downwardly on either end thereof to form legs, each end of the rope handle member is formed into a knot;

FIG. 16 is a top view of the embodiment of a stackable ice mold as shown in FIG. 15;

FIG. 17 is a side view of the embodiment of a stackable ice mold as shown in FIG. 15; and

FIG. 18 is a front view of the embodiment of a stackable ice mold as shown in FIG. 15.

### DETAILED DESCRIPTION OF THE INVENTION

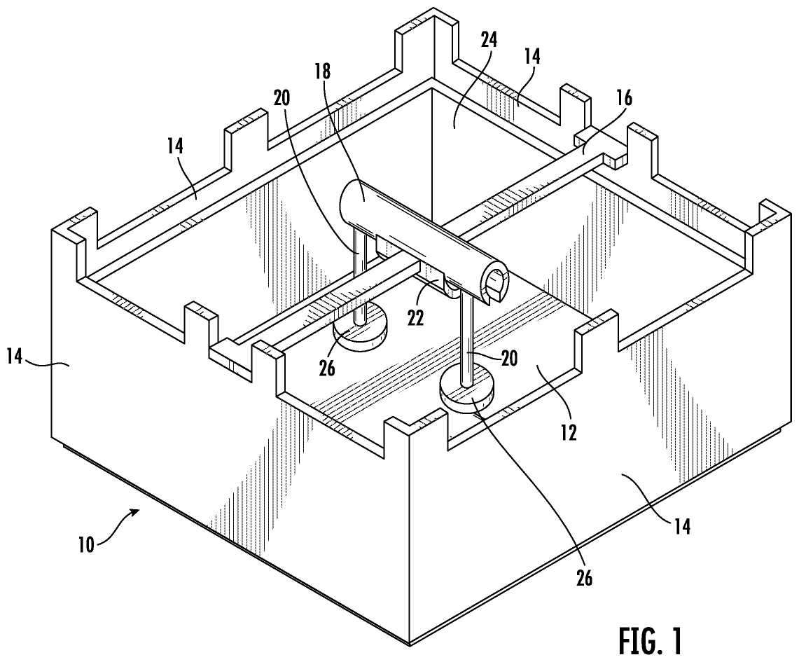

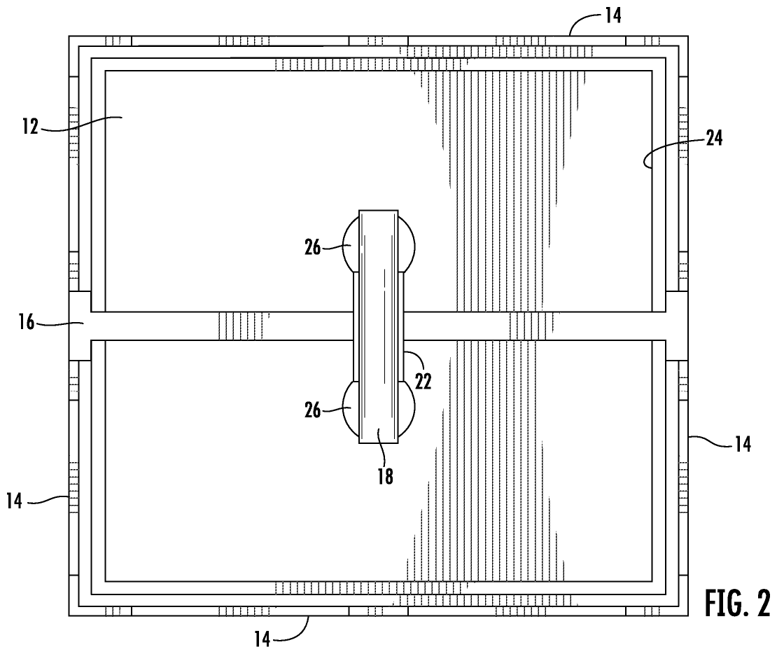

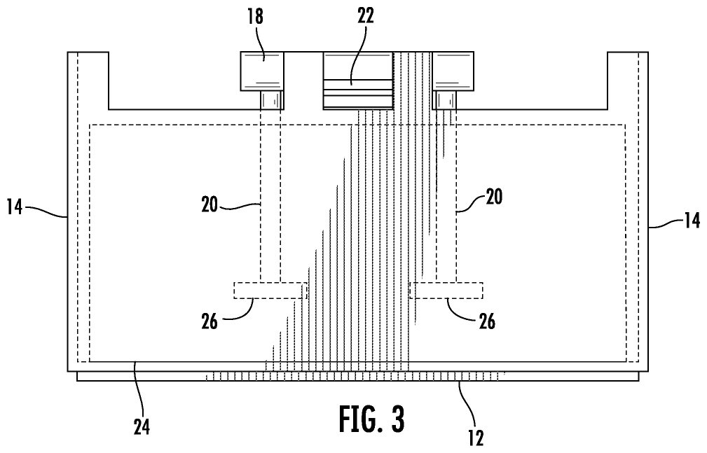

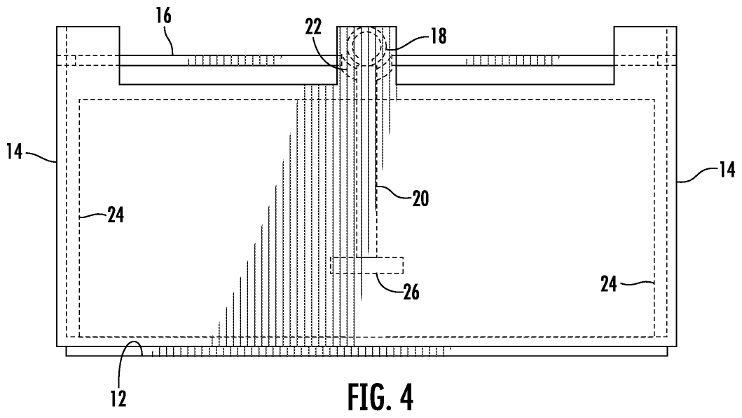

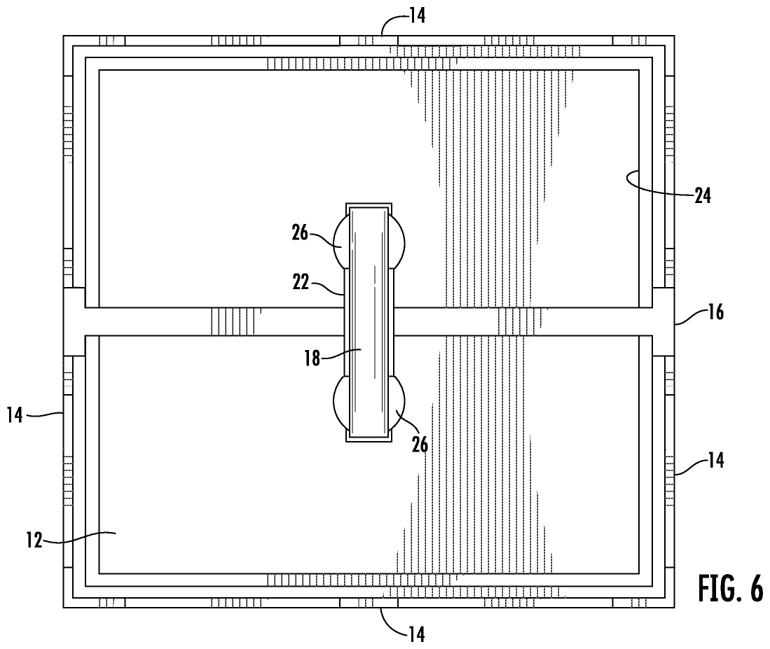

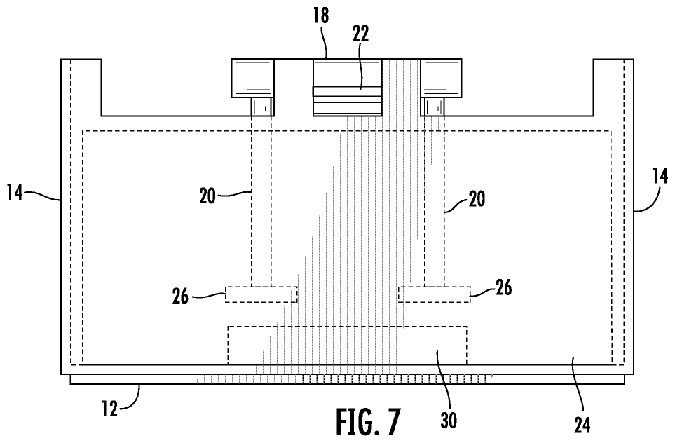

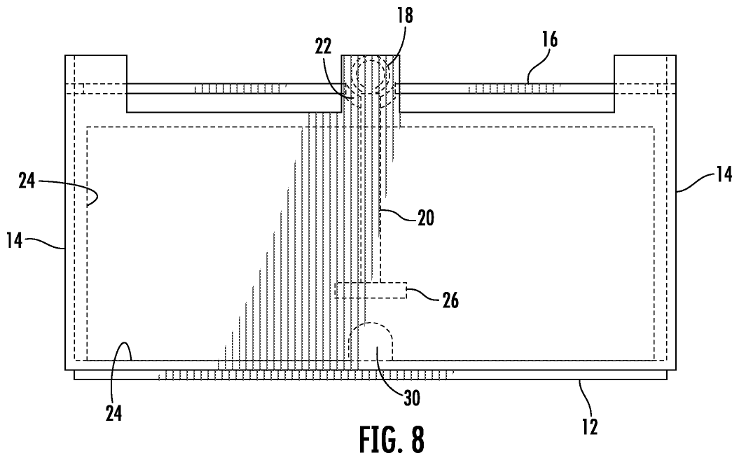

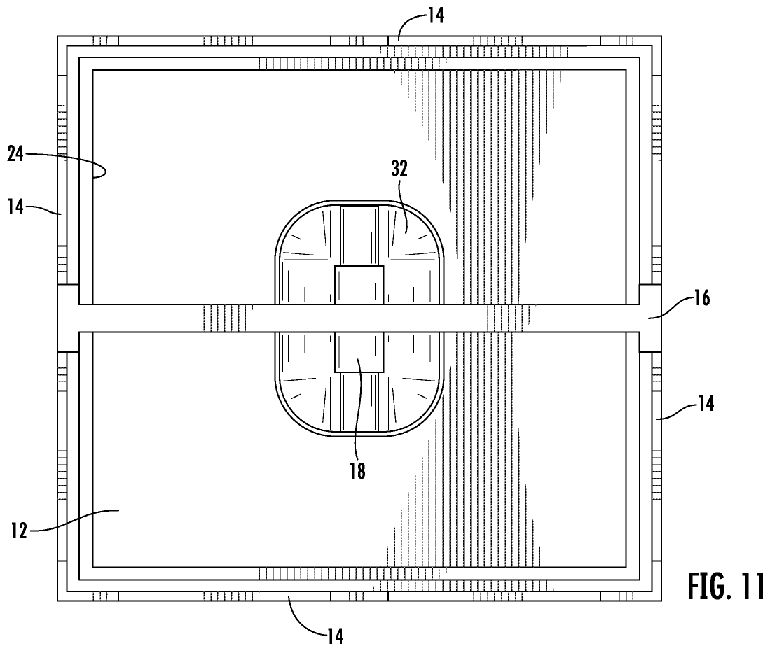

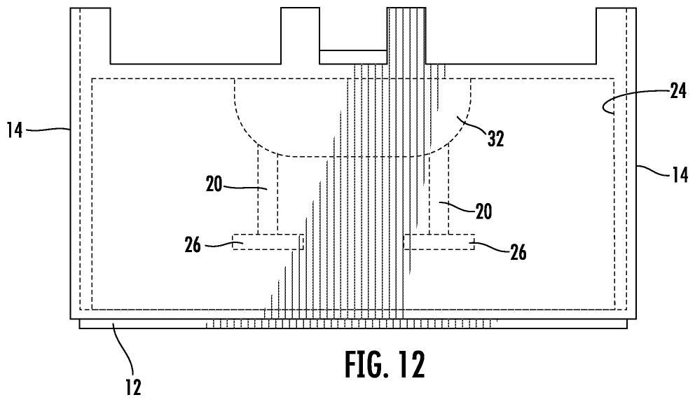

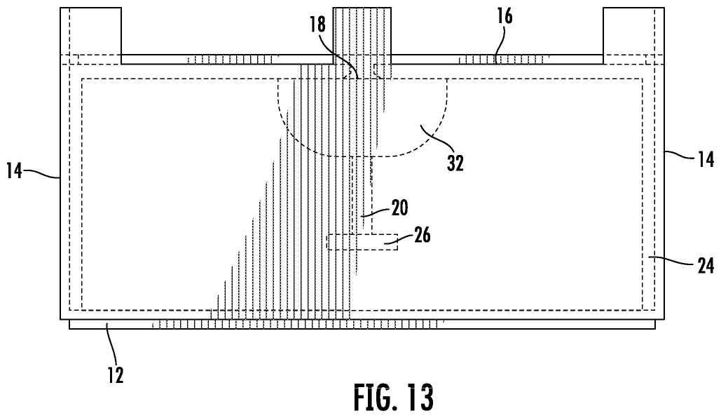

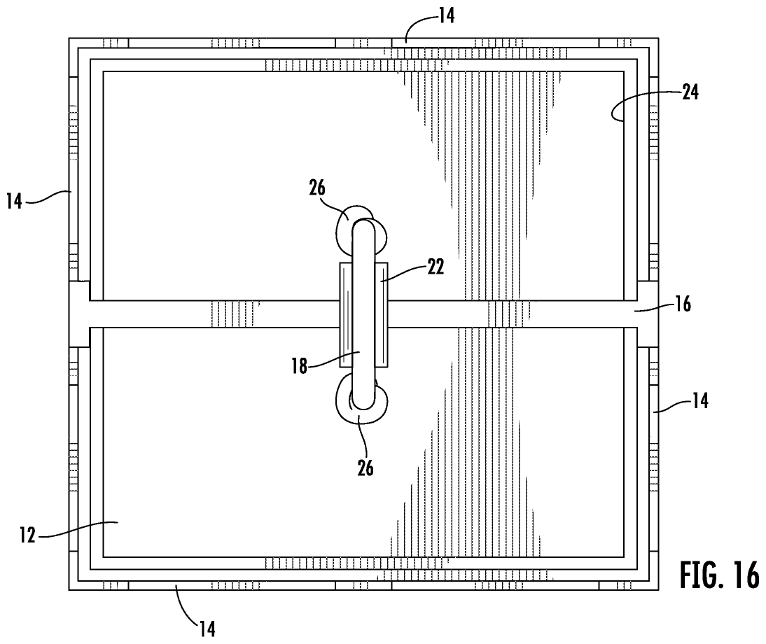

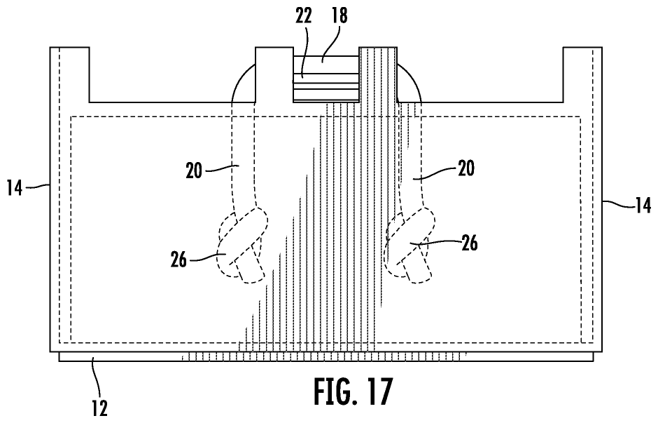

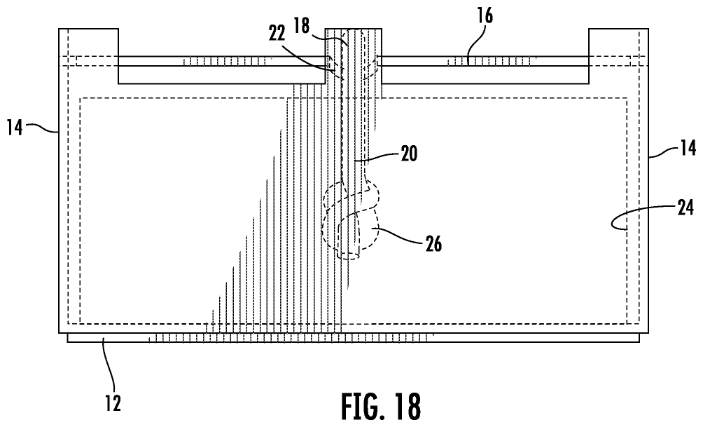

As shown in FIGS. 1-18, the present invention includes, in one embodiment, a stackable ice block mold 10 having a bottom 12 and four sides 14 to form a block of ice, a removable support bar 16 that extends across an upper portion of ice block mold 10 from one side 14 to an opposing side 14 thereof, and a handle member 18 that includes a pair of legs 20 extending downwardly therefrom.

As shown in the embodiment illustrated in FIGS. 1-4, the handle member 18 is positioned above the removable support bar 16 in this embodiment, and the legs 20 extend downwardly into the ice block mold, below the water level. The removable support bar 16 may further include a cradle 22 extending transversely across the removable support bar 16, as shown, in order to support the handle member 18. The removable support bar 16 may be placed into indentions within the opposed sides of the ice mold, as shown. Alternatively, the removable support bar 16 may be snap fit onto opposed sides 14 of the mold 10, or otherwise removably held in position with respect to the ice block mold 10 in any desired manner, so long as the removable support bar 16 may be removed and separated from the ice and the ice block mold 10 once the ice block is frozen. Preferably, a liner 24 is used to facilitate removal of the ice block from the mold 10. The liner 24 is preferably made from silicone, although it should be understood that any suitable material may be used for the liner, including plastic bags or the like. It should also be understood that a liner 24 is not required for use with the ice block mold 10.

In use, the liner 24 is placed into the ice block mold 10, and is filled with water to a designated fill line (preferably just below the top of the liner 24), so that the water level is below handle member 18 and the removable support bar 16, and so that the legs 20 extending downwardly from the handle member 18 are mostly submerged in the water. The bottom portions of the legs 20 may each include a flange 26 or foot, thus creating additional surface area to allow the handle member 18 and legs 20 to support the weight of the ice block 28, once the ice is frozen. After the appropriate water level has been reached, then the ice block mold 10 is placed into a freezer until the ice block 28 is frozen. In a preferred embodiment, the sides 14 of the ice block mold 10 extend above the uppermost surface of the handle member 18, so that multiple ice block molds 10 may be stacked on top of one another in a freezer. In some embodiments, the upper edge of the ice block mold 10 include crenellations, or raised portions intermittently spaced about the upper edge of the sides 14 of the mold 10, as shown.

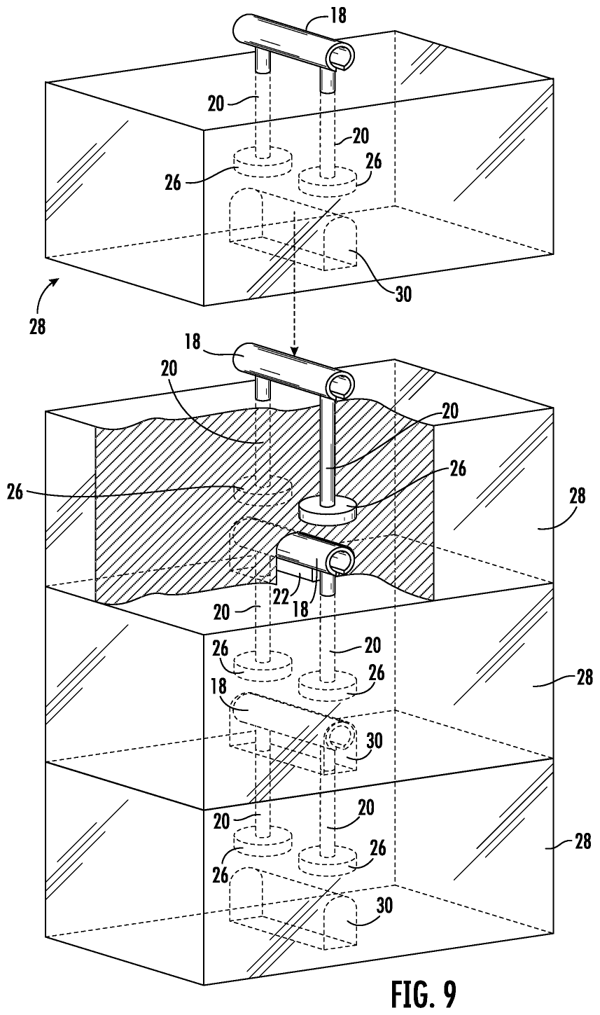

To remove the ice block 28 from the mold 10, the removable support bar 16 is removed, and a user may simply grasp the handle member 18 to pull the ice block 28 from the mold 10. If a liner 24 is used, then the liner 24 is removed from the ice block 28. The legs 20 of the handle member 18 are frozen into the ice block 28, as shown in FIG. 9, so that the handle member 18 may be used to carry and transport the ice block 28. As the ice eventually melts, the handle member 18 is then freed from the ice block 28 for re-use to make another ice block 28 in the mold 10.

In a preferred embodiment, the ice block mold 10 is made from a flexible material, such as silicone, rubber, neoprene, or any other suitable material that allows for the expansion of ice during the freezing process without cracking or breaking the mold itself. Similarly, the removable support bar 16 may be manufactured from the same type of material as the ice mold 10, so that it may expand or contract along with the mold 10 itself as the temperatures dictate. Alternatively, the removable support bar 16 may be made from any other suitable material, and is not required to be made from the same material as the mold 10 itself.

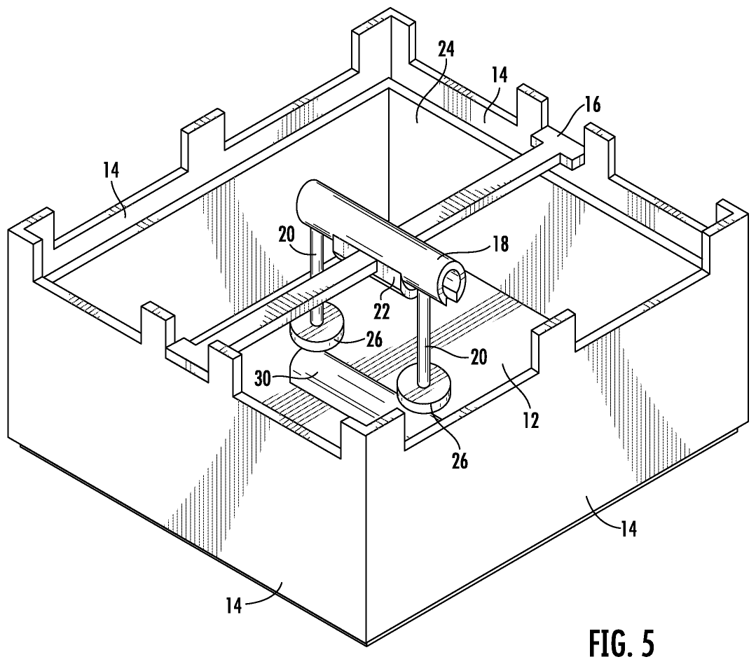

In another embodiment, as shown in FIGS. 5-8, the ice mold 10 may further includes a raised section 30 at the bottom 12 of the mold 10, positioned directly below the handle member 18. In this version, the raised section 30 at the bottom 12 of the mold 10 creates an indentation in the ice block 28, so that the ice blocks 28 may be stackable with the handles 18 attached, as shown in FIG. 9. In other words, the indentation from the raised section 30 in the bottom 12 of the ice mold 10 creates space to receive the handle 18 in a stacked configuration, so that when one ice block 28 is placed on top of another ice block 28 after removal from the molds 10, the handle 18 of the lower ice block 28 is received into the indentation at the bottom of the upper ice block 28, as shown. This feature has the added benefit of providing a stabilizing mechanism, as the handle 18 from a first ice block 28 prevents movement of a second ice block 28 that is placed squarely on top of the first ice block 28, as shown in FIG. 9.

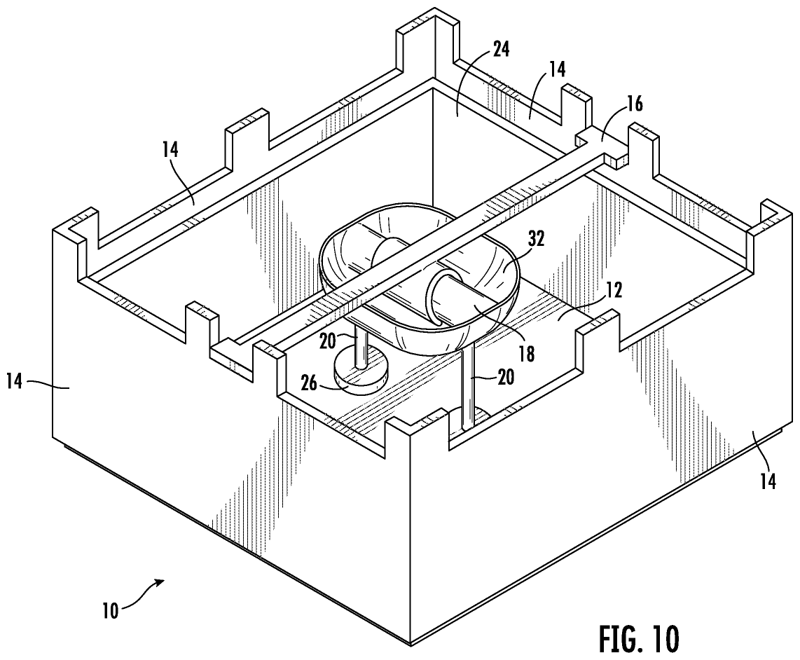

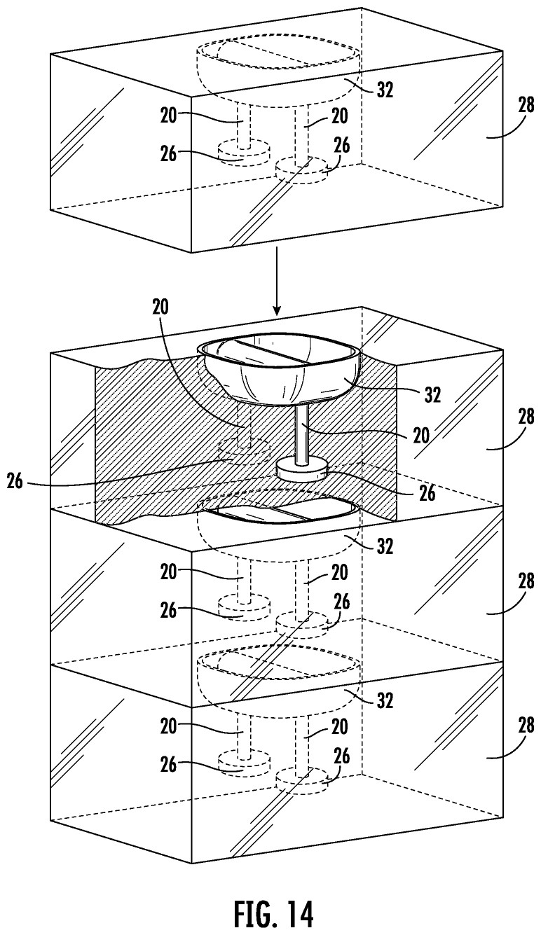

In another embodiment, the handle member includes a hemispherically shaped shield or hand guard 32 that extends below the handle member 18 itself, as shown in FIGS. 10-13. In this embodiment, the uppermost portion of the handle member 18 is generally flush with the water level, and the hand guard 32 displaces the water around the handle member 18, so that the handle member 18 is recessed into the ice block 28. The arrangement between the handle member 18 and the removable support bar 16 is different in this embodiment, as the removable support bar 16 is positioned above the handle member 18, and is removably attached thereto. For example, the removable support bar 16 may include a snap-fit cradle 22 on an underside thereof, so that the handle member 18 may simply snap into place and be removably secured in place on the cradle 22 during the freezing process. In this version, the water fill line of the mold 10 (or liner 24) is slightly below the edge of the hand guard member 32 around the handle, so that the hand guard 32 and handle 18 are generally recessed into the water, and ultimately are recessed into the ice block 28. This arrangement allows ice blocks 28 to not only be stackable, but to include recessed handles 18 frozen into place within the ice block 28 for transport and ease of carrying, as shown in FIG. 14.

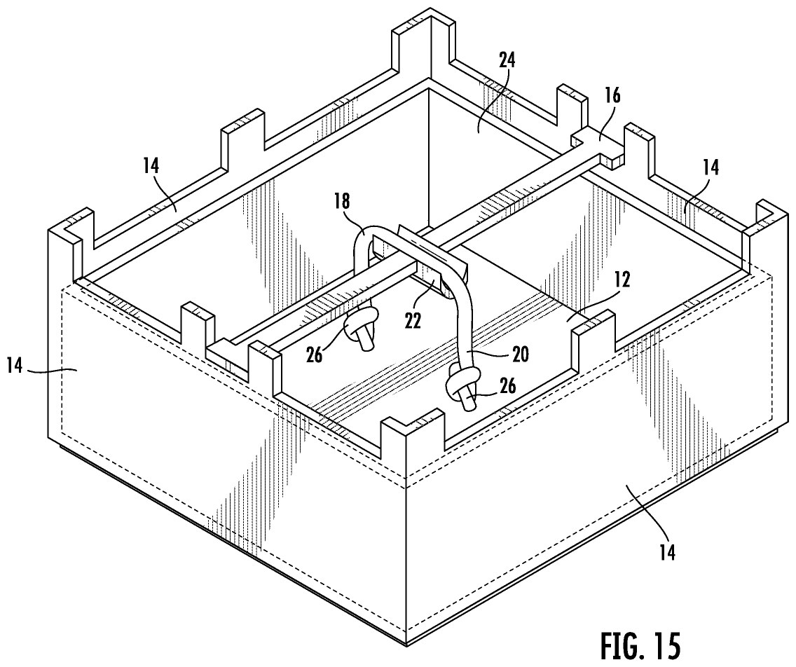

The handle member 18 may be made from any suitable material, including metal or plastic, or may even be formed from a flexible or foldable material, such as rope, as shown in FIGS. 15-18. It is contemplated that the handle member 18 may be disposable, or may be reusable. Although not required, the feet 26 at the bottom of the handle member legs 20 may take any suitable form and shape, although a preferred embodiment is generally a flange 26 extending around the base of the legs 20, as shown. In the embodiment wherein a rope or other flexible handle member is used, the ends of the rope may be tied into a knot at each end thereof, in order to provide additional surface area for bonding with the surrounding ice, as shown in FIGS. 15-18.

In some embodiments, the mold 18 may be collapsible, similarly to a cardboard box. For example, the sides 14 may pivot along the bottom edges of each side, where each side is conjoined to the bottom 12. Scores, hinges, or any other suitable pivoting mechanism may be used for this purpose. Thus, the sides may be disconnected from one another, and may fold in a stackable manner over the bottom in a flat, collapsed configuration. Alternatively, the sides may be completely removed from the bottom and from each other, rather than forming a pivoting relationship, as mentioned above. The sides may include snap-fit mechanisms so that the sides snap together along their conjoined edges in removable fashion (they also un-snap), or the sides may be removably attached to one another completely, so that they may be removably assembled for use and disassembled or collapsed for purposes of storage and transport. Essentially, the mold 18 may be collapsible and capable of reassembly in any suitable manner, as is known in the art of collapsible boxes, containers, and the like.

Although the present invention has been described in considerable detail with reference to certain preferred versions thereof, other versions are possible. Therefore, the spirit and scope of the appended claims should not be limited to the description of the preferred versions contained herein. All features disclosed in this specification may be replaced by alternative features serving the same, equivalent or similar purpose, unless expressly stated otherwise. Thus, unless expressly stated otherwise, each feature disclosed is one example only of a generic series of equivalent or similar features.

1. A stackable ice mold comprising:
a mold having a bottom and four sides for forming a block of ice;
a removable support extending from an upper portion of a first side to an opposed side;
a handle member including a pair of legs extending downwardly therefrom;
wherein said handle member is positioned above said removable support so that said legs of said handle member extend downwardly toward said bottom of said mold; and
wherein water may be placed into said mold to form an ice block, and wherein said legs are at least partially frozen within said ice block, thereby forming an ice block with said handle member attached thereto.

2. The stackable ice mold set forth in claim 1, wherein said removable support member includes a transversely oriented cradle member for supporting said handle member.

3. The stackable ice mold set forth in claim 2, wherein said cradle member is positioned on a top side of said removable support member.

4. The stackable ice mold set forth in claim 3, wherein said cradle member forms a removable snap fit mechanism for receiving said handle member.

5. The stackable ice mold set forth in claim 1, wherein said bottom of said ice mold includes a raised portion directly below said handle member for creating an indentation on a bottom portion of said ice block, so that multiple ice blocks may be stacked on top of one another, wherein said handle member of a lower ice block is received into said indentation of an upper ice block.

6. The stackable ice mold set forth in claim 1, wherein said ice mold is collapsible for purposes of storage and transport.

7. A stackable ice mold comprising:
a mold having a bottom and four sides for forming a block of ice;
a removable support extending from an upper portion of a first side to an opposed side;
a handle member including a pair of legs extending downwardly therefrom;
wherein said handle member is positioned below said removable support so that said legs of said handle member extend downwardly toward said bottom of said mold; and
wherein water may be placed into said mold to form an ice block, and wherein said legs are at least partially frozen within said ice block, thereby forming an ice block with said handle member attached thereto.

8. The stackable ice mold set forth in claim 7, wherein said handle member includes a shield member so that said handle member and shield member may be recessed into said ice block.

9. The stackable ice mold set forth in claim 7, wherein said removable support includes a cradle member on an underside thereof for attachment to said handle member.

10. The stackable ice mold set forth in claim 7, further including a cradle member for supporting said handle member.

11. The stackable ice mold set forth in claim 10, wherein said cradle member includes a snap-fit configuration for removably securing said handle member thereto.

12. A method for forming an ice block with a handle member for carrying said ice block, said method comprising the steps of:
providing an ice mold;
providing a handle member, said handle member including at least one leg extending downwardly from said handle member;
inserting liquid water into said ice mold so that at least a portion of said leg of said handle member is submerged in said liquid water; and
freezing said liquid water to form an ice block so that said portion of said leg is frozen within said ice block.

13. The method set forth in claim 12, further comprising the steps of:
providing a hand guard member about said handle member, and
forming said ice block so that said handle member and said hand guard are recessed into an upper side of said ice block.

14. An ice block comprising
frozen ice having a flat top surface; and
a handle member having at least one leg extending downwardly from said handle into said frozen ice, so that said handle supports said ice block for carrying and transport purposes.

15. The ice block set forth in claim 14, further comprising a hand guard attached to said handle member.

16. The ice block set forth in claim 15, wherein said hand guard and said handle member are recessed into said flat top surface.

17. The ice block set forth in claim 14, wherein said ice block includes a flat bottom surface having an indentation therein for receiving a handle member from a second ice block within said indentation when said ice blocks are disposed in a stacked configuration.
